(19) United States
(12) Patent Application Publication
(10) Pub. No.: US 2026/0024266 A1
(43) Pub. Date: Jan. 22, 2026

(54) Hair Rendering Using Hair Meshes

(71) Applicant: Cyber Radiance LLC, Salt Lake City, UT (US)

(72) Inventors: Cem Yuksel, Salt Lake City, UT (US); Gaurav Bhokare, Salt Lake City, UT (US); Elie Diaz, Bountiful, UT (US)

(21) Appl. No.: 19/274,450

(22) Filed: Jul. 18, 2025

Related U.S. Application Data
(60) Provisional application No. 63/673,168, filed on Jul. 18, 2024.
(60) Provisional application No. 63/843,226, filed on Jul. 13, 2025.

(51) Int. Cl. G06T 15/00; G06T 13/40; G06T 15/08; G06T 17/20; G06T 19/20

(52) U.S. Cl. CPC G06T 15/005; G06T 13/40; G06T 15/08; G06T 17/20; G06T 19/20; G06T 2210/36; G06T 2210/52; G06T 2219/2024

(57) ABSTRACT

Hair meshes are known to be effective for modeling and animating hair in computer graphics. This invention describes how the hair mesh structure can be used for efficiently rendering strand-based hair models on the GPU with on-the-fly geometry generation that provides orders of magnitude reduction in storage and memory bandwidth. One embodiment of the invention uses mesh shaders to carefully distribute the computation and a custom texture layout for offloading a part of the computation to the hardware texture units. The invention also describes a set of procedural styling operations to achieve hair strand variations for a wide range of hairstyles and a consistent coordinate-frame generation approach to attach these variations to an animating/deforming hair mesh. In addition, the invention describes level-of-detail techniques for improving the performance of rendering distant hair models. The results from one embodiment of the invention show an unprecedented level of performance with strand-based hair rendering, achieving hundreds of full hair models animated and rendered at real-time frame rates on a consumer GPU.

### CROSS-REFERENCE TO RELATED APPLICATIONS

This application claims the benefit of U.S. Provisional Patent Applications 63/673,168 filed Jul. 18, 2024 and 63/843,226, filed Jul. 13, 2025, both titled “Hair Rendering Using Hair Meshes,” both of which are hereby incorporated herein by reference in their entireties.

### TECHNICAL FIELD

The present disclosure relates to computer program products and computer implemented systems for rendering hair-like structures.

### BACKGROUND

Hair is an important visual component of virtual characters. Hair-like materials are prevalent in many computer graphics situations. Therefore, artists can be helped by being able to use tools for creating, visualizing, and manipulating hair models for virtual characters, as well as other surfaces with hair-like characteristics, such as grasses, fur, and so on.

The shape of a virtual character's hair and the rate at which it can be changed and rendered on a screen significantly affect the visual appearance of the character. In real life, hair is often associated with faces and used to recognize a person and/or characterize their beauty. Because of this, the hair in virtual characters is heavily scrutinized and used to judge the quality, desirability, and value of the software attempting to mimic real human qualities.

However, realistic hairstyles form complicated geometric structures that make them very difficult to model. A real human head generally has on the order of 100 thousand hair strands and, depending on the length and style, each hair strand can require a curve with many (on the order of 100) control points. Therefore, a typical full hair model can easily exceed a million vertices, making it particularly expensive for real-time rendering.

The immense geometric complexity of hair has always been a challenge for real-time rendering. Earlier methods avoided this complexity by representing hair as a surface with a texture, severely limiting the quality and the realism of the rendered models. As graphics processing units GPUs became more powerful, strand-based hair rendering emerged as an attractive, though expensive, alternative.

The geometric complexity of strand-based hair rendering not only requires a substantial amount of computation but also incurs the cost of data movement when each strand is explicitly stored. Besides the additional storage cost, this data movement can easily become the bottleneck of GPU rendering performance.

A common approach to mitigating these problems is using a small number of guide hairs that are used for determining the shapes of other hair strands. However, without any additional information, this can only generate hairs that simply interpolate the guides. Therefore, the state-of-the-art methods expect a full hair model with all hair strands as input, then for each hair vertex compute interpolation weights of neighboring guide hairs, and finally use these weights for linear hair skinning (LHS) during rendering to generate the full-resolution hair model by interpolating these guide hairs. This approach is very effective for efficiently animating strand-based hairstyles by only computing the deformations of the guide hairs. However, it must still store the interpolation weights, which can easily take as much space or more as storing the individual hair vertex positions. That is why rendering full-resolution hair models remains expensive in practice for real-time graphics applications.

### BRIEF SUMMARY

The present invention relates to rendering methods and computing systems for fast generation of hair-like models and rendering the models for display. The computing systems and methods achieve surprising and unexpected speed by generating the model for each frame using the relatively small-sized hair mesh, which avoid storing the generated hair-like model in random access memory (RAM). Instead, each rendering generates a new model from the hair mesh. But, unlike known methods that use guide strands, the current methods can deform and stylize all the individual strands in the hair-like model leading to much more realistic hair-like objects at speeds that exceed methods that use guide strands.

One embodiment of the invention relates to a computer-implemented graphics method for representation of hair-like geometry that includes storing in RAM a hair mesh. The hair mesh includes (i) a plurality of surfaces that form slices of a volumetric structure, the plurality of surfaces including at least one origin surface, each surface including a plurality of faces that form the surface; (ii) a plurality of vertices and vertex connections associated with the volumetric structure and defining a shape of the hair mesh; and (iii) a plurality of extrusions, each extrusion originating from a face of the at least one origin surface and extending through a set of connecting faces. The method also includes generating one or more renderings with hair-like attributes using a processor. Each rendering is generated by (i) providing the hair mesh to the processor; (ii) generating individual hair-like strands from the hair mesh, each strand defined by a curve passing through a point on one or more of the connecting faces of an extrusion; and (iii) applying one or more styling operations to the individual hair strands, each styling operation altering the shape of the strand's curve. Finally, the method includes providing the one or more renderings to a display.

In some embodiments, the one or more renderings form a series of renderings that produce a hair-like animation. High-resolution animation can be achieved by generating different hair models for each of a series of renderings. The shape of the volumetric structure and the individual hairs of the model can be altered (i.e., generated differently) from one rendering to the next by changing the parameters of the mesh, including modifying the vertices of the mesh structure and/or by applying styling operations with different parameters.

The series of renderings can be computed at a frame rate faster than at least 10, 20, 30 50, or 100 frames per second by using the hair mesh to produce the individual strands of the model for each frame. And the individual rendered frames can include one or more than one hair model and each model can have more than 100, 1000, 10,000, 100,000, or even 1,000,000 individual strands while still maintaining real-time frame rates.

This contrasts with traditional methods in which the model information is stored in RAM to avoid performing the computationally expensive act of generating the individual hair strands at each frame. Surprisingly, the speed with which individual hair strands can be generated and stylized using the technique described herein is faster than reading the ready model from RAM and rendering it using state-of-the-art techniques. Consequently, it is slower to move the generated and stylized model into RAM and reuse it than it is to just discard the model and regenerate the model again for each frame.

In another embodiment, the hair-like model is associated with an object in the rendering (e.g., a scalp, animal body, or inanimate object or surface). The computer-implemented graphics method can define an object space and a styling space. The object-space is the coordinate system for the object and it is used for specifying its shape, such as the positions of its vertices. The styling space is a local coordinate system defined inside the hair mesh and used by the styling operations. The transformation from the styling space to the object space can be different for different points inside the hair mesh and this transformation depends on the object-space shape of the hair mesh. The styling operations applied at a point inside the hair mesh use a coordinate frame that is transformed from the styling space to the object space. If the hair mesh deforms, the transformations change accordingly and the shape of each hair-like strand defined by the styling operations deforms along with the hair mesh. This can be used for generating animations of a hair-like model by animating/deforming the hair mesh. For example, if the object moves or deforms, such as a human rotating her head, the hair mesh (in this example) can be moved or deformed accordingly along with the transformations from styling space to object space, causing the hair strand shapes defined by styling operations to deform and rotate with the hair mesh. Using these transformations, the series of renderings can be generated at high speed, even though the hair mesh is associated with an animated object in the series of renderings.

### BRIEF DESCRIPTION OF THE DRAWINGS

Non-limiting and non-exhaustive implementations of the disclosure are described with reference to the following figures, wherein like reference numerals refer to like parts throughout the various views unless otherwise specified. It will be appreciated by those of ordinary skill in the art that the various drawings are for illustrative purposes only. The nature of the present disclosure, as well as other embodiments in accordance with this disclosure, may be more clearly understood by reference to the following detailed description, to the appended claims, and to the several drawings.

FIG. 1A illustrates a two-dimensional hair mesh with three layers;

FIG. 1B illustrates hair strand curves generated from the hair mesh of FIG. 1A;

FIG. 1C illustrates the hair strand curves of FIG. 1B, with a styling operations applied to the strands;

FIG. 2A illustrate a three-dimensional hair mesh;

FIG. 2B shows the origin slice of a hair-like texture of the mesh of FIG. 2A.

FIG. 2C illustrates the slices of the hair-like texture of FIG. 2B with additional slices;

FIG. 3A shows a seem in the rendered hair geometry without using the continuous styling transformations of the invention;

FIG. 3B shows a hair rendering according to the invention that avoids the seem shown in FIG. 3A; and

FIG. 4 illustrates a vertex in a hair mesh according to one embodiment of the invention.

### DETAILED DESCRIPTION

The present invention uses a hair mesh structure [Yuksel et al. 2009a] [Wu and Yuksel 2016] for accelerating real-time strand-based hair rendering on the GPU and managing its geometric complexity. Hair meshes were previously designed as a method for modeling hair. A hair mesh is a volumetric structure formed by extruding polygonal faces of an object model (e.g., a scalp model). The individual hair strands are generated within these extrusions, which are then modified using a variety of styling operations that define the geometric variations of hair strands. This allows the user to precisely specify the overall shape of a hair model, circumventing the geometric complexity of individual strands. In addition, hair meshes allow automatically placing the internal vertices of the volumetric structure, allowing the user to concentrate on the external surface of a hair model, thereby bringing hair modeling close to polygonal modeling of typical surfaces, commonplace in computer graphics.

In some embodiments, we generate hair strands during rendering within GPU shaders using a given hair mesh and a set of styling parameters that control the styling operations that specify individual strand shapes. This avoids the need for storing strand-based hair data, which can easily take hundreds of megabytes, and updating it as the hair moves/deforms. Instead, hair motion is captured by simulating the hair mesh and animating the styling parameters, reducing the amount of data to be stored and managed by several orders of magnitude.

To improve real-time rendering one or more of the following may be applied to the methods: (i) Organize the computation workload to match the SIMD parallelization of mesh/compute shaders. (ii) Use a novel texture-space layout of the hair mesh data for utilizing the hardware texture units to efficiently perform the interpolation operations and curve generation within the volumetric embedding of the hair mesh. (iii) Use a consistent method for local coordinate-frame generation needed for applying styling operations that adapt to arbitrary deformations of the hair mesh. (iv) Use procedural styling operations that can generate a wide variety of hairstyles from a small set of parameters. (v) Use level-of-detail techniques to automatically reduce the geometry to be generated, allowing a large collection of hair models to be efficiently rendered.

The results show that the frameworks described herein can render hundreds of unique strand-based hair models (without instancing) at real-time frame rates on current GPUs, offering an unprecedented geometric complexity for real-time hair rendering on high-end GPUs of today and making strand-based hair rendering a more affordable option for lower-end devices. The present invention can be used to show a scene with hundreds of characters with full-resolution strand-based unique hair models with individual animations, (simulated and) rendered at real-time frame rates.

### Hair Mesh Structures

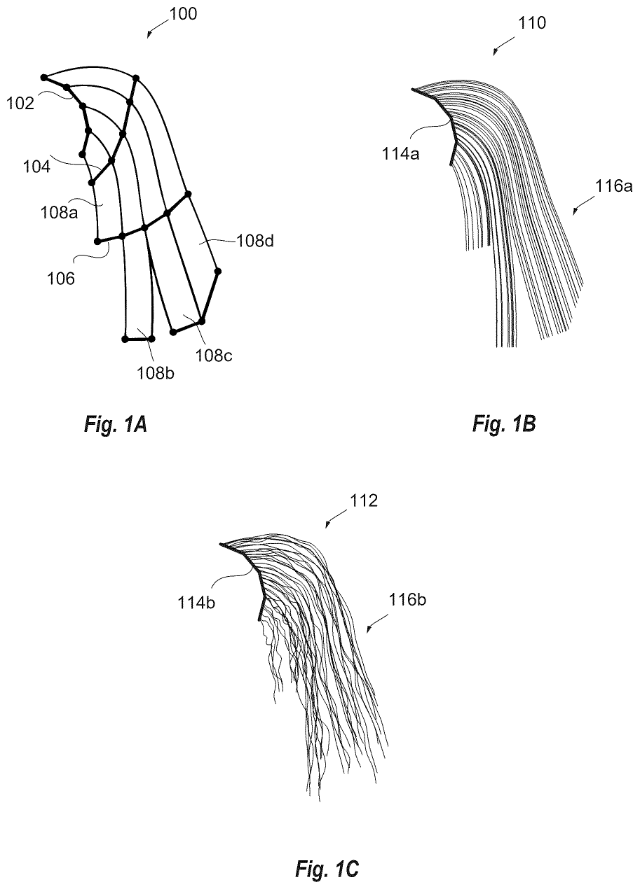

FIG. 1A illustrate a two-dimensional hair mesh structure 100 that is used to generate hair strands according to some embodiments of the invention. Hair mesh structure 100 includes 4 bundles (bundles 108a-108d) extruded from a scalp mesh (origin layer 102) at the root level. FIG. 1B shows hair strands 116a generated from the hair mesh 100 of FIG. 1A and associated with a scalp surface 114a of head object. FIG. 1C shows stylized hair 112, which included stylized strands 116b after applying a stylizing procedure to hair strands 116a.

The hair mesh structure 100 can be considered as a plurality of layers of extrusions on a polygonal object model (e.g., a scalp model), as shown in FIG. 1. The origin layer 102 (also referred to as the origin surface or root layer) is the starting point for the extrusion of a plurality of hair-like structures. The origin layer may be a scalp mesh, sometimes referred to as the root layer where the hair-like geometry is hair attached to a head.

The hair mesh can be used to create other hair-like geometries, and the hair-like geometries are not limited to the head. For example, the hair meshes can be used to generate fur or vegetation such as dense grass. Those skilled in the art will recognize that the descriptions herein related to the scalp layer can be applied to other origin surfaces.

Multiple layers of extrusions starting from one origin mesh 102 (or other origin surface) form a bundle such as bundles 108a-108d. Thus, each origin-layer face corresponds to a different bundle. The individual hair-like strand curves are generated within these extruded bundle volumes. The origin position of each hair-like strand corresponds to a barycentric coordinate on a face of the object model (e.g., a scalp). This forms the first control point of the strand curve. The other control points are formed using the same barycentric coordinate on successive extrusion layers from the same object face. Any curve formulation, such as cubic Catmull-Rom splines with centripetal parameterization, can be used to form a curve from these control points. The vertices of the hair mesh on successive extrusions over the same origin vertex are connected using the same curve formulation, forming curved edges along the hair-like growth direction and corresponding curved external surfaces.

Since the hair meshes form volumetric structures, many of their vertices are hidden behind their external surfaces. For simplifying the volumetric modeling process, these internal vertices can be placed automatically, based on the user-specified positions of the external hair mesh vertices that appear on their external surfaces.

The individual hair-like strands generated from a hair mesh, as described above, form a uniform hair-like flow within the hair mesh volume, lacking any variation between neighboring strands. Such variations are introduced via a set of styling operations. These are typically random perturbations or procedural functions applied to the vertices of a hair-like strand, which are initially placed along the strand curve generated from the hair mesh. For example, a barycentric embedding of a hair-like strand can be used within the hair mesh for defining the coordinate frame in which these styling operations are applied, so that these variations follow the deformations of an animating hair mesh.

The hair mesh and/or the styling operations can be generated manually or automatically. For instance, the mesh and/or the styling parameters can be generated using software such as the Hair Farm plugin for 3 ds Max. The mesh or styling parameters can also be generated using a large language model (LLM). The LLM can be trained on hair-like models or 3D strand-based models to generate a hair mesh output and/or stylizing parameters. The LLM can be prompted using text and/or images, including hand drawn images, or data from a 3D scanner, to create the hair mesh or stylization parameters. The hair mesh or stylization parameters can be used directly or imported into a 3D application and modified using techniques known in the art.

The on-the-fly hair-like generation method described herein can be customized for the computation process of the GPU cores and for utilizing texture filtering units to offload some computations. The methods can produce on-the-fly hair generation that avoids the cost of storing the full-resolution hair-like model.

Rendering with Hair Meshes

The strand-based hair-like rendering approach of the invention allows converting the hair mesh into a special texture for using the texture filtering hardware to accelerate the generation of a hair-like strand curve from a hair mesh. In some embodiments, mesh/compute shaders can be used to generate hair-like strands from the given hair mesh during rendering. This typically involves placing the hair-like strand origins, perturbing their vertices via a series of styling operations, and computing their tangent directions, which is needed for shading. In some embodiments, further acceleration is achieved by applying level-of-detail by dynamically reducing the number of hair-like strands generated and the vertex count per strand based on the camera distance.

### Hair Mesh Textures

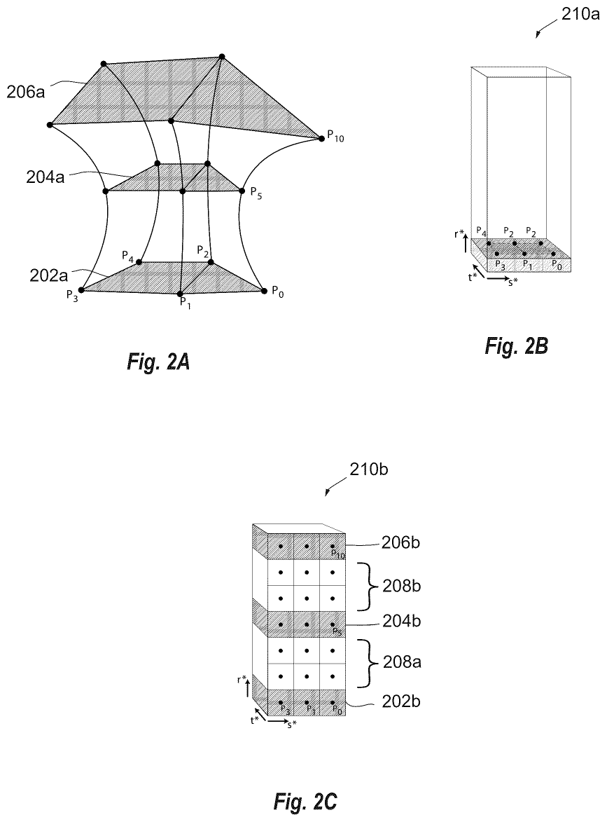

In some embodiments, hair mesh textures are used to store the vertex positions of the given hair mesh. FIGS. 2A-2C illustrate example three dimensional hair mesh structures that can be used and the methods for generating them. The textures can be used to send custom data to the GPU shaders. The hair mesh texture is structured to take advantage of the texture filtering hardware available on the GPU to perform some of the interpolation computations needed during hair-like strand generation.

Without loss of generality, quad-dominant hair meshes can be formed by extruding an origin mesh (scalp mesh) of quads and triangles. Any origin face (and its bundle) that is a higher-degree polygon can be trivially split into quads/triangles.

FIG. 2A shows a 3D representation of a hair mesh structure according to one embodiment of the invention. The origin layer 202a has a triangle formed from P₀, P₁, and P₂ and a rectangle formed from P₁, P₂, P₃, and P₄. Layers 204a and 206a have corresponding geometry. For instance, point P₅ in layer 204a corresponds with P₀ in origin layer 202 and Pio in layer 206a. Those skilled in the art will appreciate that all or a substantial portion of the vertices of layers 202a, 204a, and 206a will have corresponding vertices that corresponds with vertices in their adjacent layers.

The hair mesh texture can be stored as a standard 3D texture on the GPU, with each texel storing a 3D position in object space. Three vectors such as st, t*, and r* can be used to denote the orthogonal coordinate frame of this texture 210a (FIG. 2B). The texels on its first 2D slice perpendicular to the r* direction correspond to the origin layer of the hair mesh and can be called the origin slice (FIG. 2B). The texels of the origin slice store the origin-layer vertex positions (e.g., vertex positions of the scalp mesh). For each quad face of the origin layer, the vertex positions are copied to the texels of a 2×2 block on the origin slice. Triangle faces are handled by duplicating one of their vertices, such as P₂ in FIG. 2B, and similarly copying onto 2×2 blocks.

This allows using the texture filtering hardware to compute a bilinear interpolation of the four vertices of a quad face during hair-like generation. Given a point p* on the origin slice of the hair mesh texture between the centers of a 2×2 block of texels (the rectangle formed by P₁-P₄ in FIG. 2B), sampling this texture at p* returns the corresponding object-space coordinate p by bilinearly interpolating these four root-layer vertex positions.

This process also works for triangle faces of the scalp by adjusting the sampling position. The vertex positions of the hair mesh on successive layers are copied onto other 2D slices of the hair mesh texture 210a to form the texture 210b shown FIG. 2C. Each texel in the texture can be referred to as a layer slice, with each layer corresponding to a specific slice perpendicular to the r* direction of the 3D texture. This allows using hardware trilinear interpolation to compute the 3D position within the hair mesh volume.

If the hair strands are cubic splines, we cannot rely on a single trilinear interpolation between layers of a hair mesh to compute a position along the curve. For supporting cubic spline interpolation, each segment of the spline can be converted into a cubic Bézier curve with 4 control points. Then, control points can be placed on four successive intermediate slices (e.g., slices 208a and 208b) of the 3D texture, placed between layer slices 202b, 204b, and 206b. Then, any point along the curves within a bundle of the hair mesh can be computed by three trilinear interpolations (between three successive slices) followed by three linear interpolations, using de Casteljau's algorithm. This way, the texture filtering unit performs most of the computation needed for both bilinear interpolations within the bundle and the evaluation of the interpolated hair spline at any point along the hair.

Alternatively, Seiler interpolation can be used by storing Seiler points in the intermediate slices of the 3D hair mesh textures. In this case, only two trilinear interpolations (between the layers and their Seiler points) using the texture filtering unit followed by a single linear interpolation in software is sufficient to evaluate the curve.

In general, the topology of an arbitrary scalp mesh may not be suitable for simply copying all its vertex positions on the 2D lattice of the root slice. Such cases can be easily handled by splitting the scalp mesh into multiple pieces to be copied onto the hair mesh texture separately.

The mapping of the hair mesh root layer onto the root slice of the hair mesh texture can be prepared manually or it can be automated, while the successive layers along the r* direction are handled automatically based on the given 2D mapping. While the foregoing methods of creating the mesh textures have been illustrated with a certain number of layers, vertices, and object type, those skilled in the art will recognize that more layers and vertices can be used and the object being extruded can be an object other than hair from a scalp.

### Hair Generation on the GPU

The present invention also relates to generating hair strands on the GPU during rendering. These strands are re-generated for each render pass, rather than being stored. This means repeating some computations that could otherwise be shared between passes and even frames. On the other hand, eliminating the storage of hair strands, which can easily take hundreds of megabytes for a single hair model, is a substantial saving that more than justifies repeated computation during rendering. Nonetheless, to achieve the best trade-off, the hair generation workload can be organized to match the computation flow of the GPU hardware. In some embodiments, parallel hair generation process can be achieved using GPU mesh/compute shaders.

On-the-fly hair generation on the GPU can use tessellation shaders, though this approach can limit the number of hair vertices and the number of hair strands that can be generated per patch. To avoid this, mesh/compute shaders can be used.

Compute shaders can be used if hair generation will be followed by software rasterization. This might be favorable, since hair strands often turn into many small triangles that can be rendered more efficiently in software than hardware rasterizers on current GPUs. Embodiments of the invention that rely on the hardware rasterizer, can advantageously perform the hair generation method using mesh shaders. Nonetheless, the process of the invention can be applied to compute shaders as well. In some embodiments, the methods of the invention can also be implemented using vertex shaders to shape individual hair strands, which are provided as copies of an instanced geometry.

Three levels of parallelism can be used with the hair meshes:
1. Bundle-level: A hair mesh contains multiple bundles.
2. Strand-level: Each bundle contains multiple hair strands.
3. Vertex-level: Each hair strand contains multiple vertices.

In some embodiments, the mesh shaders execute at the strand-level parallelism. The computation load is distributed to the operation of GPU cores that work in SIMD blocks of S threads, where S varies by hardware (typically 32 or 64). To maximize occupancy the mesh shader workload can be split into groups of s threads, where S is a multiple of s.

Each mesh shader thread in a SIMD block computes n vertices, where a hair strand is formed by ns+1 vertices. Computing a vertex involves evaluating its initial curve position within the hair mesh by sampling the hair mesh texture multiple times followed by linear interpolation and then applying procedural styling operations. One exception is the root vertex of the strand, which only requires a single lookup of the hair mesh texture on the root slice without applying any other interpolation or styling perturbation, since styling is not applied to the root vertices. The resulting hair strand curves can be rendered as camera-facing triangle strips each with 2 ns+2 vertices and 2 ns triangles.

A task shader can be spawned for each hair mesh bundle. The task shader determines the number of hair strands to be generated within its bundle, which may involve culling and level of detail, as explained herein. Then, it spawns as many mesh shaders as the number of hair strands to be rendered for that bundle. Thus, task shaders work with bundle-level parallelization, strand-level parallelization is exploited with different mesh shader instances, and the SIMD cores running a mesh shader utilize the vertex-level parallelization.

A compute shader implementation may need handling task shader operations that determine the number of hair strands per bundle and the total number of compute shader executions. This can be performed on the CPU prior to dispatching the compute shaders or it can be handled as an initial pass with compute shaders on the GPU.

Then, compute shaders can operate similarly to the mesh shaders, followed by software rasterization. An alternative implementation of compute shaders can switch between task shader and mesh shader computations, which can require implementing a software schedular.

A vertex shader implementation can similarly compute the number of hair strands to be rendered on the CPU. Then, for each rendered strand, an instance of a hair strand model can be rendered and the shape of the hair strand is computed within the vertex shader, where each execution of the vertex shader computes the position of a single hair vertex.

### Hair Root Placement

A hair strand is uniquely defined by its root position within the hair mesh. Therefore, placing a hair strand within a bundle can be achieved by simply picking a random root location for it. This can be done using a precomputed set of 2D sample locations ξ=[ξₛ ξt]^{T} within [0, 1]². A sample is chosen using the local index of a hair strand and mapped onto the root slice of the hair bundle.

To achieve a natural placement of hair roots, a blue noise distribution for precomputing the 2D sample locations can be used. A blue noise distribution can be generated by sample elimination [Yuksel 2015] or any other method. The sample elimination method allows generation of a progressive sample set, such that any number of samples taken from the beginning of the set forms blue noise. In some implementations, the same set of random samples can be used for all bundles. To achieve more variety multiple sets of random samples can be precomputed, each bundle using a different set. For picking root positions on triangle scalp faces, a different set of precomputed 2D sample locations can be used. This is because using the sample set generated for a quad face on a triangle would bias the hair root locations towards the duplicated vertex in the hair mesh texture layout. Instead, the sample set for triangles can be generated using sample elimination within ξ∈[0, 1]² but by first selecting samples within a triangular half, such that ξₛ+ξₜ<1. Then, we map them onto ξ^{Δ}=[ξₛ^{Δ}ξₜ^{Δ}]^{T}∈[0, 1]² within the full quad space, such that ξₛ^{Δ}=ξₛ(1−ξₜ) and ξₜ^{Δ}=ξₜ. Using bilinear interpolation with ξ^{Δ} corresponds to barycentric interpolation with coordinates ξₛ, ξₜ, and 1−ξₛ−ξₜ, where the barycentric coordinate, corresponds to the duplicated vertex on the hair mesh texture layout.

### Styling Coordinates

Hair styling is a process that alters the shapes of individual hair strands and specifies the geometric variations between them. It is typically applied as a set of procedural functions or random offsets altering hair vertex positions. While examples of styling operations are provided herein, those skilled in the art will recognize that other styling operations can be used as well.

An important component of the styling process is defining the local styling coordinates that should remain consistent as the hair mesh deforms. The styling perturbations of hair vertices can be defined within these local styling coordinates. The amplitudes of the styling perturbations, however, are defined in the object space, so that they are not scaled by expansions/contractions of the hair mesh bundles, which can happen when the hair mesh is animated.

This objective can be achieved by defining a texture-space embedding of the hair mesh. Similar to standard texture mapping, hair mesh vertices at the root layer are placed on a 2D texture space by specifying their uv coordinates. Just like texture mapping, seams may be introduced and some root layer vertices along seams can be placed at multiple locations within this 2D texture space. This process is handled manually or simply copied from the uv layout of the scalp mesh.

For handling the extruded layers of the hair mesh, the texture space is extended to 3D with uvw coordinates. Extrusions of the hair mesh bundles take their uv coordinates from their corresponding root layers, but are assigned a different w coordinate, such that w=0 at the root layer with increasing w towards the tip layers. These w coordinates are provided as a part of the hair mesh, but they can also be automatically generated based on the length of the path from each vertex to its root.

The texture-space coordinates of a hair mesh can be recorded in two textures. The first one is the uv-texture, a 2D version of the hair mesh texture, storing only the uv coordinates. The layout of this 2D uv-texture can match the root slice layout of the hair mesh texture, but it only records the uv values of the hair mesh. The second one is the w-texture, which is a 3D texture similar to the hair mesh texture but only stores the scalar w values. Unlike the hair mesh texture, however, w-texture needs no intermediate slices. For a given position p* in the hair mesh texture, the two textures can be sampled to find the corresponding uvw coordinate.

Many styling operations can be computed based on the uvw coordinate. However, the resulting styling perturbation directions d^{τ} are defined in this 3D texture space. These texture-space directions can be transformed to the corresponding object-space directions d=M_{p*}d^{τ} using a transformation matrix M_{p*}=[u v w], where û, \hat{v}, and ŵ are the object-space vectors that correspond to the texture-space û^{τ}, \hat{v}^{τ}, and ŵ^{τ} directions at position p* of the hair mesh texture.

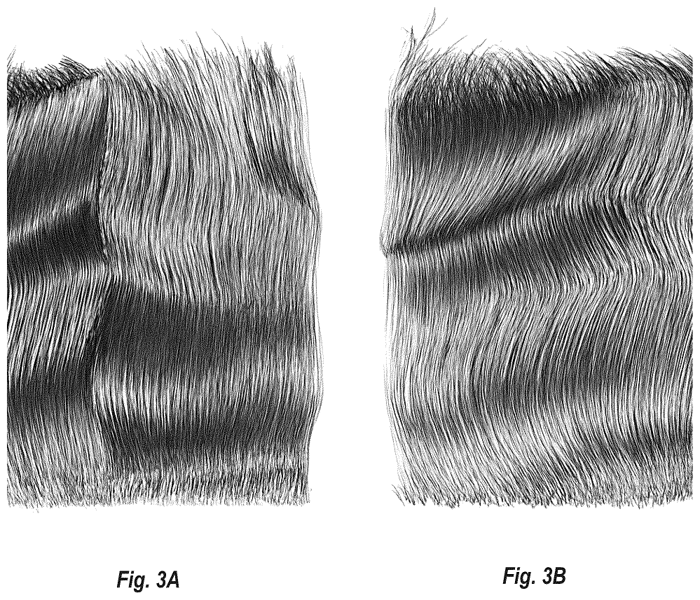

For computing these object-space vectors û, \hat{v}, and ŵ, a simple solution uses finite difference by sampling the hair mesh texture around p*. Yet, besides the numerical issues of finite difference, this approach can produce less desirable results because it may not form a continuously rotating coordinate frame within the hair mesh. This is because the uvw coordinates vary linearly within a bundle and object-space û, \hat{v}, and ŵ directions computed for a bundle can be arbitrarily different from the ones within a neighboring bundle. Therefore, using finite differences could lead to styling perturbations that change discontinuously, forming visible seams between hair mesh bundles. This problem is illustrated in FIGS. 3A and 3B. The finite difference method shown in FIG. 3A shows a visible seem whereas the method of the present invention shown in FIG. 3B does not.

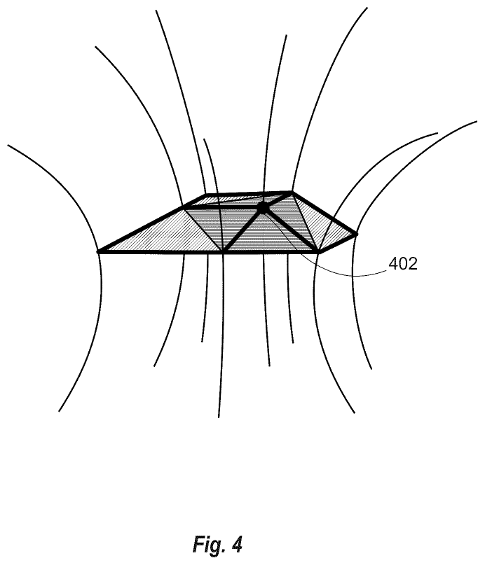

To ensure a continuous transformation of styling perturbations, we define consistent object-space û, \hat{v}, and ŵ directions for each vertex of the hair mesh, which are shared by all neighboring bundles using the same vertex. The û direction of a hair mesh vertex is defined as the weighted average of all linearly-transformed directions ûᵢ determined by each triangle i that surrounds the vertex 402 (e.g., triangles containing vertex 402 and its two edges) at the same layer of the hair mesh, as shown in FIG. 4. Thus,

$$\hat{u} = \frac{u}{‖ u ‖} with u = \frac{{\sum }_{i} {A}_{i} {u}_{i}}{{\sum }_{i} {A}_{i}}$$

where Aᵢ is the texture-space area of the triangle i.

This linear transformation for a triangle i can be represented by a 2×2 matrix Tᵢ, such that

$$T = [ \begin{matrix}{u}_{1} - {u}_{0} & {u}_{2} - {u}_{0} \\ {v}_{1} - {v}_{0} & {v}_{2} - {v}_{0}\end{matrix} ]$$

where uⱼ and vⱼ with j∈{0, 1, 2} are the uv coordinates of the three vertices of the triangle.

Let pⱼ be their object-space positions. We can transform the texture-space û^{τ} and \hat{v}^{τ} for this triangle using

$$[ {u}_{i} {v}_{i} ] = [ {p}_{1} - {p}_{0} {p}_{2} - {p}_{0} ] {Ti}^{- 1} .$$

Note that this process does not guarantee that û, \hat{v}, and ŵ directions at a hair mesh vertex are perpendicular, thus the transformation of the resulting coordinate frame may include skew. We define w as the orthogonal direction to both û and \hat{v}, such that

$$\hat{w} = ( \hat{u} \times \hat{v} ) / ‖ \hat{u} \times \hat{v} ‖$$

We precompute the û, \hat{v}, and ŵ directions for the hair mesh vertices and store them in two separate 3D textures, u-texture and v-texture, which are stored similarly to the hair mesh texture by recording the computed û and \hat{v} vectors instead of positions. Just like our w-texture, we do not need intermediate slides for these two textures either. Thus, u and v are obtained by single lookups.

As the hair mesh deforms, the textures that contain object-space positions and directions are updated: hair mesh texture, u-texture, and v-texture. The other textures (uv-texture and w-texture), do not need any dynamic updates.

### Example Styling Operations

To introduce small-scale variations between hair strands we can apply a set of procedural styling operations using the styling coordinates. Though the styling operations described herein can generate various hairstyles, the invention is not limited to these particular operations. Note that these styling operations can be, but are not required to be, applied to the root vertex.

The formulations below we assume a normalized w coordinate, such that w=0 at the root and w=1 at the hair tip. Most of the styling operations use a noise function to determine the direction and magnitude of the perturbation.

Fuzz adds a random perturbation to each hair strand. The same perturbation direction is used for all vertices of a hair strand, determined by the hair strand index or its uv coordinate at the root. Its amplitude a, defined in object space, increases from root to tip, the rate of which is controlled by a user-defined exponent parameter b. The resulting fuzz perturbation of a vertex can be written as

$$d = a {{w}^{b} [ cos \begin{matrix}ϕ & sin ϕ & 0\end{matrix} ]}^{T} {( {ζ}_{a} )}^{c}$$

where ϕ=2πζ_{ϕ} is a random angle, ζₐ, ζ_{ϕ}∈[0, 1]² are random numbers associated with the hair strand, and c is another exponent parameter that controls the magnitude distribution.

Frizz computes a perturbation direction at the root uv coordinate of each hair strand using the noise function and applies the same perturbation to the entire hair strand. Frizz is similar to fuzz, except for the noise function that replaces the random direction of fuzz. It uses amplitude a and exponent b parameters, along with noise frequency f parameter, resulting

$$d = a {w}^{b} ψ ( {[ \begin{matrix}uf & vf & 0\end{matrix} ]}^{T} )$$

where ψ(p) is the noise function that returns a direction for the given 3D position p in texture space. Notice that frizz samples the noise direction at the root, where w=0.

Kink works similar to frizz, but computes a different perturbation for each hair vertex. Kink uses amplitude a and exponent b parameters as well, but it has two frequency parameters: fᵤᵥ for the u and v coordinates and f_{w} for the w coordinate, such that

$$d = a {w}^{b} ψ ( {[ \begin{matrix}{uf}_{uv} & {vf}_{uv} & {wf}_{w}\end{matrix} ]}^{T} ) .$$

Curl applies a spiral function to achieve a curly hairstyle. In addition to amplitude a and exponent b parameters, it receives the number of spiral rotations r, the noise frequency f for shifting the phase, and a second exponent parameter c that shifts the spiral rotations towards the tip or the root, resulting

$$\begin{matrix}d = a {{w}^{b} [ cos θ sin θ 0 ]}^{T} \\ θ = 2 π r ( ψ ( {[ uf vf 0 ]}^{T} ) + {w}^{c} )\end{matrix}$$

where ψ(p) is a scalar noise function.

Clumping is defined on a regular grid of size m×m covering the uv texture space. The uv value at the center of a grid cell defines a reference strand. Vertices p of hair strands within the same grid cell are moved towards the corresponding vertex of the reference strand p_{c} using

$$d = ( {p}_{c} - p ) ( 1 - h a / ‖ {p}_{c} - p ‖ ) {w}^{b} ,$$

where h∈[0,1] is the texture-space distance of the hair strand from the clump center normalized by the texture-space clump size, a is the object-space clump thickness parameter, and b is the exponent parameter. For breaking the uniformity of this grid structure, we find the clump center of a hair strand after adding a noise offset to its uv coordinate.

We compute the object-space position of the reference strand p_{c} by sampling the hair mesh texture at the corresponding position of the clump center p^{τ}_{c}. For evaluating p^{τ}_{c}, we precompute tip positions p^{τ}_{c-tip} and store them in a 2D texture. This process involves rendering the tip-layer faces of the hair mesh onto a texture of m×m resolution using the uv coordinates of the hair mesh tip vertices. To break the uniformity of the grid structure, we can apply the same noise function above after finely tessellating each tip-layer face tessellation. The empty texels of this texture are filled by copying neighboring non-empty texel values.

We use another parameter p∈[0,1] to determine the percentage of hair strands to be included in clumping. Whether a hair strand should be included in a clump is determined by a random number in [0,1] that can be generated based on the hair strand index (within a clump) or its original uv coordinate.

### Hair Tangents

Hair tangent directions can be used for shading. In some embodiments they may be computed using finite differences or the analytical derivatives of the procedural styling operations to determine the infinitesimal tangent direction at each hair vertex we compute. However, in addition to the extra computation cost of evaluating such a tangent direction, it may not be representative of the final hair strand shape we generate. This is because the styling functions can have a higher frequency than what we can reliably represent using the number of vertices computed. Therefore, it can be beneficial to use cheaper and simpler schemes. For example, let k∈{0, 1, . . . , ns} represent the index of a vertex along a hair strand, where k=0 corresponds to the root vertex.

Assign the tangent direction tₖ as the vector from the previous vertex to the next vertex, such that tₖ=pₖ₊₁−pₖ₋₁, except for the first and the last vertices. The tangent of the last vertex can be set such that its angular separation with the last hair segment pₙₛ₋₁ to pₙₛ matches the angle of the previous tangent tₙₛ₋₁, using

$${\hat{t}}_{ns} = 2 {\hat{q}}_{ns} ( {\hat{t}}_{ns - 1} \cdot {\hat{q}}_{ns} ) - {\hat{t}}_{ns - 1}$$

where \hat{q}ₖ=(pₖ−pₖ₋₁)/∥pₖ−pₖ₋₁∥ is the last segment direction and \hat{t}ₖ=tₖ/∥tₖ∥. Similarly, the tangent of the first vertex is set as

$${\hat{t}}_{0} = 2 {\hat{q}}_{1} ( {\hat{t}}_{1} \cdot {\hat{q}}_{1} ) - {\hat{t}}_{1} .$$

This particular way of defining the tangents of the endpoints can achieve consistent shading when changing the number of hair vertices with level-of-detail.

### Level-of-Detail

On-the-fly hair generation allows two level-of-detail (LOD) types by dynamically reducing the number of hair strands and the number of vertices per hair strand.

In some embodiments, a simple scheme can be used for determining the detail level L for either of the LOD types. It can be based on the minimum distance d to the camera, the vertical image resolution R, and a user-defined scaling parameter a that controls the performance/quality trade-off, such that

$$L = min ( 1 , \frac{hR}{d tan θ} α ) ,$$

where θ is the camera's field of view and h is the world-space hair model size that can be interpreted differently for the two LOD types.

When using an orthographic camera, such as when rendering shadows for a directional light, the d tan θ term can be replaced by the view height in world space.

The number of hair strands in each bundle and the number of vertices per hair strand are scaled by L, subject to some restrictions as described herein. The main challenge with level-of-detail is ensuring seamless transitions between detail levels.

The α value that would provide a good trade-off between quality and performance can be different for different hairstyles. Also, it can be favorable to use two different α parameters for the two LOD types, so that they can be tuned independently.

Strand Level-of-Detail. When reducing the number of hair strands with LOD, it is preferred to avoid suddenly removing a large number of hair strands at once with a slight change in L, since that would make the detail transitions more noticeable.

Consider a hair mesh with F bundles, each with exactly N hair strands. If we simply calculate the number of hair strands to be generated using [LN], all F bundles would reduce their hair strand count simultaneously, so the effective detail levels would differ by exactly F hair strands.

To reduce the likelihood of such abrupt transitions a random increment δᵢ∈[0, 1) can be added to the number of hair strands Nᵢ computed for each bundle i. The resulting number of hair strands for bundle i is calculated as

$${N}_{i}^{LOD} = ⌈ L ( {N}_{i} + {δ}_{i} ) ⌉ .$$

Though this simple solution does not guarantee that all detail levels for a hair model would differ by exactly one hair strand, it greatly reduces the likelihood of detail levels that differ by a large number of hair strands. The equation above also ensures that each bundle is assigned at least one hair strand for L>0.

When reducing hair strands with LOD, it can be beneficial to compensate for the reduction in hair material. We accomplish this by increasing the thickness of hair strands by a factor of min (1/L, Nᵢ). Notice that this increase in hair thickness is not synchronized with discrete reductions in hair count to minimize the amount of geometry difference between detail levels.

For computing L, a measure of the hair bundle's thickness as h can be used, such as the bundle's scalp face size (i.e. the radius of its bounding sphere or length of its longest edge) at rest shape, since bundles that appear thinner on screen can be approximated by rendering fewer hair strands.

Vertex Level-of-Detail. Though it is possible to reduce the hair vertex count by increments of 1, doing so can cause problems. First, it becomes more difficult to maintain full SIMD occupancy with an arbitrary number of hair vertices. Second, levels may have distinctly different geometry, making it difficult to seamlessly transition between levels. This is because the styling functions can have strong high-frequency components along a hair strand, beyond what can be represented with the given number of hair vertices.

One solution to avoid these issues ensures that the number of strand vertices is always a power of 2 plus 1. First, pick powers of 2 values for both the number of threads s and the number of vertices computed per thread n for the highest-resolution LOD. A lower-resolution level is formed by replacing either n or s with a smaller power of 2, n^{LOD}=2^{e}^{ₙ} and s^{LOD}=2^{e}^{ₛ}, respectively. The desired level is formulated using

$$e = {e}_{n} + {e}_{s} = max ( 0 , ⌈ {log}_{2} ( Lns ) ⌉ )$$

that results in 2^{e}+1 hair vertices. Any combination of eₙ≥0 and eₛ≥0 that satisfies e=eₙ+eₛ can be used.

In practice, replacing n with n^{LOD} can be implemented easily. Replacing s with s^{LOD}, however, is not as trivial, since s is a compile-time constant, determining the number of threads to be used by the mesh shader. Therefore, it is advisable to use s=s^{LOD}, keeping eₛ constant and only modifying eₙ. If eₛ must be modified, the mesh shader can be configured to generate multiple hair strands, instead of a single hair strand per execution, or different pre-compiled shader programs can be used for different values of eₛ.

In addition, it can be beneficial to have the LOD transition seamless when reducing the number of vertices. This can be achieved by geometrically transitioning between detail levels.

Let λ∈[0, 1] be a user-defined parameter defining the transition window between two detail levels. We define the next detail level using

$$\tilde{e} = max ( 0 , ⌈ {log}_{2} ( Lns ) - λ ⌉ ) .$$

When e>\tilde{e}, we transition between levels by morphing the higher-resolution strand shape towards the lower-resolution one. This is accomplished by moving each computed higher-resolution vertex position pₖ with an odd index k toward the centers of its neighbors, such that the updated vertex position p′ₖ is

$${p}_{k}^{′} = ( 1 - γ ) {p}_{k} + γ \frac{{p}_{k - 1} + {p}_{k + 1}}{2} ,$$

Where γ is the transition factor, calculated using

$$γ = 1 - \frac{{log}_{2} ( Lns ) - \tilde{e}}{2} .$$

This morphs the strand shape between two levels. The tangent directions can also be adjusted to ensure that the change in the appearance of the shaded strand is also continuous. This can be achieved by computing two sets of tangents: tₖ using the original positions pₖ and \hat{t}ₖ that only uses the vertex positions with even k (the vertices that will remain in the lower-resolution level), such that \hat{t}ₖ with even k is computed similarly and \hat{t}ₖ with odd k is set as the average (\hat{t}ₖ₋₁+\hat{t}ₖ₊₁)/2.

Then, we simply morph the tangents for all hair vertices to calculate the updated vertex tangents \hat{t}′ₖ using \hat{t}′ₖ=(1−γ)tₖ+γ\hat{t}ₖ.

Examples of other techniques for level-of-detail methods that can be used with the present invention include [Liu et al. 2017; Mercier et al. 2022; Zhu et al. 2022] [Yuksel and Tariq 2010], all of which are incorporated herein by reference.

### Example 1

The methods of the present invention were tested on an NVIDIA GTX 4090 GPU. In Example 1 we show the performance of our approach with a scene containing 100 characters, each with unique hairstyles of 100 thousand strands. The hair meshes were simulated with extended position-based dynamics [Macklin et al. 2016], using the force models of Wu and Yuksel and sag-free initialization [Hsu et al. 2022]. The hair strands were generated and rasterized in only 2 ms with 8×MSAA (multisample antialiasing), excluding pixel shading time, using the methods of the present invention with LOD. Obviously, for such a large scene LOD plays an important role; without it, the methods of the present invention takes 47 ms to rasterize hair in this scene.

### Example 2

To provide a direct comparison to LHS, the state-of-the-art method for rendering strand-based hair models in practical applications, we generated the hair models in Example 2. Example 2 generated three hair models totaling 300 thousand hair strands, generated and rasterized in 1.8 ms without antialiasing and 3.3 ms with antialiasing using the methods of the present invention. We extracted the strand data, to ensure that both methods render identical hair models. Then, 1% of these hair strands were selected as guide hairs, and LHS weights were precomputed for all hair vertices. Finally, we rasterized the resulting models using LHS, which takes 18 ms (with or without MSAA). We experimented with different numbers of guide hairs (0.1% to 10% of hairs) and did not observe a measurable performance difference. In comparison, the methods of the present invention can generate the identical models on the fly and rasterize them in 1.8 ms without LOD to produce an identical image (without MSAA), a performance improvement of 10×.

The performance difference between LHS and the methods of the present invention can be explained by the amount of data used by the two methods. While LHS requires 340 MB for these models, the textures used by the present invention only take 39 KB. Note that LOD was not used with either method in this comparison.

### Example 3

In Example 3, hairstyles were rendered from different distances to the camera with and without LOD. LOD methods of the present invention produced a similar image to rendering without LOD while substantially simplifying the generated model geometry.

### Example 4

In this example we generated 200 Utah teapots, each with a separate hair mesh and hairstyle of 50 thousand strands rendered using the method of the present invention without instancing. All hair in this scene rasterizes in 1.8 ms with 8×MSAA and 1.1 ms without MSAA using present invention with LOD. Without LOD, hair models in this scene formed 66 billion triangles, which rasterized in 150 ms using the invention. All hair strands are generated using five textures per teapot that fit in 3.2 MB for this entire scene, varying between 11 KB and 27 KB per teapot (based on hair mesh resolutions of 198 to 378 vertices).

### Example 5

In this example, we generated six different hairstyles with different sets of styling parameters. The six hairstyles had similar overall general features of the hair styles illustrated in FIG. 6A-6E. We noted that a relatively low-resolution hair model is sufficient for generating a complex strand-based hair model with intricate details. The hairstyles shown in FIGS. 6A-6E. Those skilled in the art will recognize that various other procedural styling functions can be easily integrated into the system and methods of the invention.

### Example 6

We created 200 Utah teapot models with unique hair models. Each hair model includes 50 thousand hair strands with a different set of styling parameters. The hair meshes are simulated to generate the hair animations. All hair in this scene is rasterized in 1.8 ms in total with 8×MSAA. Our 5 textures for 200 separate hair mesh models in this scene fit in 3.2 MB (17 KB per teapot on average).

Almost all hair models in Example 6 took 1 ms to rasterize. In tests, disabling all styling computations provided only about 10% to 20% improvement in the total render time.

Reference throughout this specification to “an example” means that a particular feature, structure, or characteristic described in connection with the example is included in at least one embodiment of the present disclosure. Thus, appearances of the phrase “in an example” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on its presentation in a common group without indications to the contrary. In addition, various embodiments and examples of the present disclosure may be referred to herein along with alternatives for the various components thereof. It is understood that such embodiments, examples, and alternatives are not to be construed as de facto equivalents of one another but are to be considered as separate and autonomous representations of the present disclosure.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive.

The publication titled “Real-Time Hair Rendering with Hair Meshes” by Cem Yuksel in SIGGRAPH Conference Papers '24, Jul. 27-Aug. 1, 2024, Denver, CO, USA is hereby incorporated by reference in its entirety. Provisional patent application titled “Hair Rendering Using Hair Meshes”, Ser. No. 63/673,168 filed Jul. 18, 2024 is hereby incorporated by reference in its entirety.

Those having skill in the art will appreciate that many changes may be made to the details of the above-described embodiments without departing from the underlying principles of the disclosure. The scope of the present disclosure should, therefore, be determined only by the claims, if any.

The following references are hereby incorporated herein by reference:
Edwin Catmull and Raphael Rom. 1974. A Class of Local Interpolating Splines. In Computer Aided Geometric Design. Academic Press, 317-326. https://doi.org/10.1016/B978-0-12-079050-0.50020-5.
Menglei Chai, Jian Ren, and Sergey Tulyakov. 2020. Neural Hair Rendering. In Computer Vision—ECCV 2020, Andrea Vedaldi, Horst Bischof, Thomas Brox, and Jan-Michael Frahm (Eds.). Springer International Publishing, Cham, 371-388.
Menglei Chai, Tianjia Shao, Hongzhi Wu, Yanlin Weng, and Kun Zhou. 2016. AutoHair: Fully Automatic Hair Modeling from a Single Image. ACM Trans. Graph. 35, 4, Article 116 (July 2016), 12 pages. https://doi.org/10.1145/2897824.2925961.
Menglei Chai, Changxi Zheng, and Kun Zhou. 2014. A Reduced Model for Interactive Hairs. ACM Trans. Graph. 33, 4, Article 124 (July 2014), 11 pages. https://doi.org/10.1145/2601097.2601211
A. Daldegan, N. M. Thalmann, T. Kurihara, and D. Thalmann. 1993. An integrated system for modeling, animating and rendering hair. Computer Graphics Forum 12, 3, 211-221. https://doi.org/10.1111/1467-8659.1230211 MIRALab, Geneva Univ., Switzerland.
Epic Games. 2021. Unreal Engine. https://www.unrealengine.com.
Jerry Hsu, Nghia Truong, Cem Yuksel, and Kui Wu. 2022. A General Two-Stage Initialization for Sag-Free Deformable Simulations. ACM Trans. Graph. 41, 4, Article 64 (July 2022), 13 pages. https://doi.org/10.1145/3528223.3530165
Jerry Hsu, Tongtong Wang, Zherong Pan, Xifeng Gao, Cem Yuksel, and Kui Wu. 2023. Sag-Frec Initialization for Strand-Based Hybrid Hair Simulation. ACM Trans. Graph. 42, 4, Article 74 (July 2023), 14 pages.
Songrun Liu, Zachary Ferguson, Alec Jacobson, and Yotam Gingold. 2017. Seamless: Seam Erasure and Seam-Aware Decoupling of Shape from Mesh Resolution. ACM Trans. Graph. 36, 6, Article 216 (November 2017), 15 pages. https://doi.org/10.1145/3130800.3130897
Miles Macklin, Matthias Müller, and Nuttapong Chentanez. 2016. XPBD: position-based simulation of compliant constrained dynamics. In Proceedings of the 9th International Conference on Motion in Games (Burlingame, California) (MIG '16). Association for Computing Machinery, New York, NY, USA, 49-54. https://doi.org/10.1145/2994258.2994272
Stephen R. Marschner, Henrik Wann Jensen, Mike Cammarano, Steve Worley, and Pat Hanrahan. 2003. Light Scattering from Human Hair Fibers. ACM Trans. Graph. 22, 3 (July 2003), 780-791. https://doi.org/10.1145/882262.882345
Corentin Mercier, Thibault Lescoat, Pierre Roussillon, Tamy Boubekeur, and Jean-Marc Thiery. 2022. Moving Level-of-Detail Surfaces. ACM Trans. Graph. 41, 4, Article 130 (July 2022), 10 pages. https://doi.org/10.1145/3528223.3530151
Zhong Ren, Kun Zhou, Tengfei Li, Wei Hua, and Baining Guo. 2010. Interactive Hair Rendering under Environment Lighting. In ACM SIGGRAPH 2010 Papers (Los Angeles, California) (SIGGRAPH '10). Association for Computing Machinery, New York, NY, USA, Article 55, 8 pages. https://doi.org/10.1145/1833349.1778792.
Radu Alexandru Rosu, Shunsuke Saito, Ziyan Wang, Chenglei Wu, Sven Behnke, and Giljoo Nam. 2022. Neural Strands: Learning Hair Geometry and Appearance from Multi-view Images. In Computer Vision—ECCV 2022, Shai Avidan, Gabriel Brostow, Moustapha Cissé, Giovanni Maria Farinella, and Tal Hassner (Eds.). Springer Nature Switzerland, Cham, 73-89.
Thorsten Scheuermann. 2004. Practical Real-Time Hair Rendering and Shading. In ACM SIGGRAPH 2004 Sketches (Los Angeles, California) (SIGGRAPH '04). Association for Computing Machinery, New York, NY, USA, 147. https://doi.org/10.1145/1186223.1186408
Arunachalam Somasundaram. 2015. Dynamically Controlling Hair Interpolation. In ACM SIGGRAPH 2015 Talks (Los Angeles, California) (SIGGRAPH '15). Association for Computing Machinery, New York, NY, USA, Article 36, 1 pages.
Sarah Tariq and Louis Bavoil. 2008. Real Time Hair Simulation and Rendering on the GPU. In ACM SIGGRAPH 2008 Talks (Los Angeles, California) (SIGGRAPH '08). Association for Computing Machinery, New York, NY, USA, Article 37, 1 pages. https://doi.org/10.1145/1401032.1401080
Nghia Truong, Cem Yuksel, and Larry Seiler. 2020. Quadratic Approximation of Cubic Curves. Proc. ACM Comput. Graph. Interact. Tech. (Proceedings of HPG 2020) 3, 2, Article 16 (2020), 17 pages. https://doi.org/10.1145/3406178
Lvdi Wang, Yizhou Yu, Kun Zhou, and Baining Guo. 2009. Example-based hair geometry synthesis. In ACM SIGGRAPH 2009 Papers (New Orleans, Louisiana) (SIGGRAPH '09). Association for Computing Machinery, New York, NY, USA, Article 56, 9 pages. https://doi.org/10.1145/1576246.1531362
Lingyu Wei, Liwen Hu, Vladimir Kim, Ersin Yumer, and Hao Li. 2018. Real-Time Hair Rendering Using Sequential Adversarial Networks. In Computer Vision—ECCV 2018, Vittorio Ferrari, Martial Hebert, Cristian Sminchisescu, and Yair Weiss (Eds.). Springer International Publishing, Cham, 105-122.
Kui Wu and Cem Yuksel. 2016. Real-Time Hair Mesh Simulation. In ACM SIGGRAPH Symposium on Interactive 3D Graphics and Games (I3D 2016) (Redmond, WA). ACM, New York, NY, USA, 6 pages. https://doi.org/10.1145/2856400.2856412
Kui Wu and Cem Yuksel. 2017a. Real-Time Cloth Rendering with Fiber-Level Detail. IEEE Transactions on Visualization and Computer Graphics PP, 99 (2017), 12 pages. https://doi.org/10.1109/TVCG.2017.2731949
Kui Wu and Cem Yuksel. 2017b. Real-Time Fiber-Level Cloth Rendering. In ACM SIGGRAPH Symposium on Interactive 3D Graphics and Games (I3D 2017) (San Francisco, CA). ACM, New York, NY, USA, 8 pages. https://doi.org/10.1145/3023368.3023372
Kun Xu, Li-Qian Ma, Bo Ren, Rui Wang, and Shi-Min Hu. 2011. Interactive Hair Rendering and Appearance Editing under Environment Lighting. ACM Trans. Graph. 30, 6 (December 2011), 1-10. https://doi.org/10.1145/2070781.2024207.
Ling-Qi Yan, Chi-Wei Tseng, Henrik Wann Jensen, and Ravi Ramamoorthi. 2015. Physically-Accurate Fur Reflectance: Modeling, Measurement and Rendering. ACM Trans. Graph. 34, 6, Article 185 (November 2015), 13 pages. https://doi.org/10.1145/2816795.2818080
Xuan Yu, Jason C. Yang, Justin Hensley, Takahiro Harada, and Jingyi Yu. 2012. A Framework for Rendering Complex Scattering Effects on Hair (I3D '12). Association for Computing Machinery, New York, NY, USA, 111-118. https://doi.org/10.1145/2159616.2159635
Cem Yuksel. 2015. Sample Elimination for Generating Poisson Disk Sample Sets. Computer Graphics Forum (Proceedings of EUROGRAPHICS 2015) 34, 2 (2015), 25-32. https://doi.org/10.1111/cgf.12538
Cem Yuksel and John Keyser. 2008. Deep Opacity Maps. Computer Graphics Forum (Proceedings of EUROGRAPHICS 2008) 27, 2 (2008), 675-680. https://doi.org/10.1111/j.1467-8659.2008.01165.x
Cem Yuksel, Scott Schaefer, and John Keyser. 2009a. Hair Meshes. ACM Transactions on Graphics (Proceedings of SIGGRAPH Asia 2009) 28, 5, Article 166 (2009), 7 pages. https://doi.org/10.1145/1661412.1618512
Cem Yuksel, Scott Schaefer, and John Keyser. 2009b. On the Parameterization of Catmull-Rom Curves. In 2009 SIAM/ACM Joint Conference on Geometric and Physical Modeling (San Francisco, California). ACM, New York, NY, USA, 47-53.
Cem Yuksel and Sarah Tariq. 2010. Advanced Techniques in Real-Time Hair Rendering and Simulation. In ACM SIGGRAPH 2010 Courses (Los Angeles, California) (SIGGRAPH 2010). ACM, New York, NY, USA, Article 1, 168 pages. https://doi.org/10.1145/1837101.1837102
Junqiu Zhu, Sizhe Zhao, Lu Wang, Yanning Xu, and Ling-Qi Yan. 2022. Practical Level-of-Detail Aggregation of Fur Appearance. ACM Trans. Graph. 41, 4, Article 47 (July 2022), 17 pages. https://doi.org/10.1145/3528223.3530105
Arno Zinke, Cem Yuksel, Andreas Weber, and John Keyser. 2008. Dual Scattering Approximation for Fast Multiple Scattering in Hair. ACM Trans. Graph. 27, 3 (August 2008), 1-10. https://doi.org/10.1145/1360612.1360631

What is claimed is:

1. A computer-implemented graphics method for representation of hair-like geometry, comprising:
storing in random access memory (RAM) a hair mesh, the hair mesh comprising,
(i) a plurality of surfaces that form slices of a volumetric structure, the plurality of surfaces including at least one origin surface, each surface including a plurality of faces that form the surface;
(ii) a plurality of vertices and vertex connections associated with the volumetric structure and defining a shape of the hair mesh;
(iii) a plurality of extrusions, each extrusion originating from a face of the at least one origin surface and extending through a set of connecting faces;
generating one or more renderings with hair-like attributes using a processor, wherein each rendering is generated by,
(i) providing the hair mesh to the processor;
(ii) generating individual hair-like strands from the hair mesh, each strand defined by a curve passing through a point on one or more of the connecting faces of an extrusion; and
(iii) applying one or more styling operations to the individual hair strands, each styling operation altering the shape of the strand's curve;
providing the one or more renderings to a display.

2. The computer-implemented graphics method as in claim 1, wherein the processor is a graphics processing unit (GPU) and the hair mesh is provided to the GPU as one or more hair mesh textures.

3. The computer-implemented graphics method as in claim 1, wherein the processor uses a shader to generate the one or more renderings with hair-like attributes.

4. The computer-implemented graphics method as in claim 3, wherein the shader is selected from the group consisting of vertex shaders, tessellation shaders, compute shaders, and mesh shaders.

5. The computer-implemented graphics method as in claim 1, wherein at least a portion of the surfaces have a different number of faces and/or different topological connectivity.

6. The computer-implemented graphics method as in claim 1, wherein the curve for each strand includes a collection of line segments.

7. The computer-implemented graphics method as in claim 1, wherein the one or more renderings comprise a series of renderings that produce a hair-like animation.

8. The computer-implemented graphics method as in claim 7, wherein the series of renderings is computed at a frame rate faster than at least 10, 20, 30 50, or 100 frames per second.

9. The computer-implemented method as in claim 7, wherein the animation is generated by modifying the hair mesh.

10. The computer-implemented method as in claim 1, further comprising defining an object space and a styling space, the method further comprising modifying the transformation from the styling space to object space based on the animation of the hair mesh.

11. The computer-implemented graphics method of claim 10, wherein the individual hair strands within each hair mesh extrusion are generated in parallel on the GPU.

12. The computer-implemented graphics method as in claim 1, wherein generating the individual hair strands includes generating at least 100 individual hair strands.

13. The computer-implemented graphics method as in claim 1, wherein generating the individual hair strands includes generating at least 1000 individual hair strands.

14. The computer-implemented graphics method as in claim 1, wherein generating the one or more renderings includes rasterizing the hair model using the GPU.

15. The computer-implemented graphics method as in claim 1, wherein the hair mesh is prepared manually or automatically or partially automatically.

16. The computer-implemented graphics method as in claim 15, wherein the hair mesh is partially or fully prepared by a generative algorithm.

17. The computer-implemented graphics method as in claim 15, wherein the hair mesh is partially or fully prepared by capturing data from human subjects.

18. The computer-implemented graphics method as in claim 1, wherein one or more styling operations are prepared manually or automatically or partially automatically.

19. The computer-implemented graphics method as in claim 18, wherein one or more styling operations are partially or fully prepared by a generative algorithm.

20. The computer-implemented graphics method as in claim 18, wherein one or more styling operations are defined by data captured from human subjects.

21. The computer-implemented graphics method as in claim 1, wherein generating individual hair-like strands from the hair mesh forms curves defined by a point on one or more of the connecting faces of an extrusion that do not go through said points.

22. A computer-implemented graphics method for representation of hair-like geometry, comprising:
storing in random access memory (RAM) a hair mesh, the hair mesh comprising,
(i) a plurality of surfaces that form slices of a volumetric structure, the plurality of surfaces including at least one origin surface, each surface including a plurality of faces that form the surface;
(ii) a plurality of vertices and vertex connections associated with the volumetric structure and defining a shape of the hair mesh;
(iii) a plurality of extrusions, each extrusion originating from a face of the at least one origin surface and extending through a set of connecting faces;
generating a series of renderings with hair-like geometry to form an animation of the hair-like geometry, wherein the series of renderings is generated at a frame rate of at least 20 frames per second using a graphics processing unit (GPU), wherein generating each rendering in the series includes,
(iv) providing the hair mesh to the GPU;
(v) generating at least 100 individual hair-like strands from the hair mesh, each strand following a curve defined by a point on one or more of the connecting faces of an extrusion; and
(vi) applying one or more styling operations to the individual hair strands, each styling operation altering the shape of the strand's curve;
providing the series of renderings to a display.
